(19) United States
(12) Patent Application Publication
(10) Pub. No.: US 2015/0049913 A1
(43) Pub. Date: Feb. 19, 2015

(54) ROAD SURFACE SLOPE-IDENTIFYING DEVICE, METHOD OF IDENTIFYING ROAD SURFACE SLOPE, AND COMPUTER PROGRAM FOR CAUSING COMPUTER TO EXECUTE ROAD SURFACE SLOPE IDENTIFICATION

(71) Applicant: Wei Zhong, Kanagawa (JP)

(72) Inventor: Wei Zhong, Kanagawa (JP)

(73) Assignee: RICOH COMPANY, LTD., Ohta-ku, Tokyo (JP)

(21) Appl. No.: 14/387,595

(22) PCT Filed: May 16, 2013
(86) PCT No.: PCT/JP2013/064296

§ 371 Date: Sep. 24, 2014

(30) Foreign Application Priority Data
May 31, 2012 (JP) 2012-123999
Mar. 19, 2013 (JP) 2013-055905

(51) Int. Cl. G06K 9/00; G06T 7/00; G06K 9/46

(52) U.S. Cl. CPC G06K 9/00798; G06K 9/4647; G06T 7/0065; G06T 2207/10004; G06T 2207/30256
USPC 382/104

(57) ABSTRACT

Disparity information is generated from a plurality of imaged images imaged by a plurality of imagers. Disparity histogram information that shows disparity value frequency distribution in each of line regions obtained by plurally-dividing the plurality of imaged images in a vertical direction is generated. A group of disparity values or disparity value range that is consistent with a feature in which a disparity value becomes smaller as it approaches an upper portion of the imaged image from a disparity value or a disparity value range having frequency that exceeds a predetermined specified value is selected. A slope condition of a road surface in front of a driver's vehicle with respect to a road surface portion on which the driver's vehicle travels is identified in accordance with the selected group of disparity values or disparity value range.

### TECHNICAL FIELD

The present invention relates to a road surface slope-identifying device for identifying a slope condition of a road surface on which a driver's vehicle travels based on a plurality of imaged images of a front region of the driver's vehicle imaged by a plurality of imagers, a method of identifying a road surface slope, and a computer program for causing a computer to execute road surface slope identification.

### BACKGROUND ART

Conventionally, an identifying device that identifies an identification target object based on an imaged image of a front region of a driver's vehicle is used for a driver assistance system, or the like such as ACC (Adaptive Cruise Control), or the like to reduce the load for a driver of a vehicle, for example. The driver assistance system performs various functions such as an automatic brake function and an alarm function that prevent a driver's vehicle from crashing into obstacles, and the like, and reduce impact when crashing, a driver's vehicle speed-adjusting function that maintains a distance from a vehicle in front, a supporting function that supports prevention of the driver's vehicle from deviating from a lane where the driver's vehicle travels, and the like.

In order to achieve those functions properly, from imaged images of a front region of the driver's vehicle, it is important to precisely identify an image portion that shows various identification target objects existing around the driver's vehicle (for example, other vehicles, pedestrians, road surface constituents such as lane lines, manhole covers, and the like, roadside constituents such as utility poles, guard rails, curbstones, medians, and the like, etc), recognize a travelable region of the driver's vehicle, and precisely recognize an object in order to avoid crashing. Additionally, in order to appropriately achieve the functions such as the automatic brake function, the driver's vehicle speed-adjusting function, and the like, it is useful to identify a slope condition of a road surface in a travelling direction of the driver's vehicle.

Japanese Patent Application Publication number 2002-150302 discloses a road surface-identifying device that calculates a three-dimensional shape of a white line (lane line) on a road surface based on a brightness image and a distance image (disparity image information) of a front region of a driver's vehicle obtained by imaging by an imager, and from the three-dimensional shape of the white line, defines a three-dimensional shape of a road surface on which the driver's vehicle travels (road surface irregularity information in a travelling direction of the driver's vehicle). By use of the road surface-identifying device, it is possible to obtain not only a simple slope condition such as whether the road surface in the travelling direction of the driver's vehicle is flat, an acclivity, or a declivity, but also, for example, road surface irregularity information (slope condition) along a travelling direction such that an acclivity continues to a certain distance, then a declivity follows, and further the acclivity continues.

However, in the road surface-identifying device disclosed in Japanese Patent Application Publication number 2002-150302, by calculating a three-dimensional shape of two white lines that exist on both sides of a lane on which the driver's vehicle travels from a distance image (disparity image information), and then performing interpolation processing so as to smoothly continue a region between both the white lines, a complex and high-load processing that estimates the road surface irregularity information (three-dimensional road surface shape) of the lane on which the driver's vehicle travels that exists between both the white lines is performed. Therefore, it is difficult to shorten a processing time to obtain the road surface irregularity information in the travelling direction, and there is a problem such that it is not applied to real-time processing, or the like for a moving image of 30 FPS (Frames Per Second), for example.

### SUMMARY OF THE INVENTION

An object of an embodiment of the present invention is to provide a road surface slope-identifying device that identifies a slope condition of a road surface in a travelling direction of a driver's vehicle by new identification processing, a method of identifying a road surface slope, and a computer program for causing a computer to execute road surface slope identification.

In order to achieve the above object, an embodiment of the present invention provides a road surface slope-identifying device having a disparity information generator that generates disparity information based on a plurality of imaged images obtained by imaging a front region of a driver's vehicle by a plurality of imagers, which identifies a slope condition of a road surface in front of the driver's vehicle with respect to a road surface portion on which the driver's vehicle travels based on the disparity information generated by the disparity information generator, comprising: a disparity histogram information generator that generates disparity histogram information that shows disparity value frequency distribution in each of line regions obtained by plurally-dividing the imaged image in a vertical direction based on the disparity information generated by the disparity information generator; and a slope condition identifier that performs slope condition identification processing in which a group of disparity values or a disparity value range that is consistent with a feature in which a disparity value becomes smaller as it approaches an upper portion of the imaged image from a disparity value or a disparity value range having frequency that exceeds a predetermined specified value is selected based on the disparity histogram information, and in accordance with the selected group of disparity values or disparity value range, the slope condition of the road surface in front of the driver's vehicle with respect to the road surface portion on which the driver's vehicle travels is identified.

In an embodiment of the present invention, processing is performed such that disparity histogram information that shows disparity value frequency distribution in each line region is generated based on disparity information, and a group of disparity values or a disparity value range consistent with a feature in which a disparity value becomes smaller as it approaches an upper portion of an imaged image is selected. As described later, a pixel corresponding to the group of the disparity values or the disparity value range consistent with such a feature is estimated to constitute a road surface image region that shows a road surface in front of the driver's vehicle with high accuracy. Therefore, it can be said that the selected group of the disparity values or disparity value range is equivalent to the disparity value of each line region corresponding to the road surface image region in the imaged image.

Here, in a case where a slope condition (relative slope condition) on a road surface in front of the driver's vehicle with respect to a road surface portion on which the driver's vehicle travels (road surface portion positioned directly beneath the driver's vehicle) is an acclivity, a road surface portion shown in a certain line region in an imaged image is a closer region compared to a case where the relative slope condition is flat. Therefore, in a case where the relative slope condition is an acclivity, a disparity value of a certain line region corresponding to a road surface image region in the imaged image is larger compared to a case where the relative slope condition is flat. On the contrary, in a case where the relative slope condition of the road surface in front of the driver's vehicle is a declivity, the road surface portion shown in the certain line region in the imaged image is a farther region compared to the case where the relative slope condition is flat. Therefore, in a case where the relative slope condition is a declivity, the disparity value of the certain line region corresponding to the road surface image region in the imaged image is smaller compared to the case where the relative slope condition is flat. Accordingly, it is possible to obtain a relative slope condition of a road surface portion shown in each line region in a road surface image region in an imaged image from a disparity value of the line region.

As described above, the selected group of the disparity values or the disparity value range is a disparity value of each line region in the road surface image region in the imaged image, and therefore, from the selected group of the disparity values or the disparity value region, it is possible to obtain the relative slope condition of the road surface in front of the driver's vehicle. Regarding the term “relative slope condition” here, a case where a road surface portion corresponding to each line region is positioned on an upper side with respect to a virtual extended surface obtained by extending a surface parallel to a road surface portion on which the driver's vehicle travels forward to a front region of the driver's vehicle is taken as a case where the relative slope condition of the road surface portion corresponding to the line region is an acclivity, and a case where a road surface portion corresponding to each line region is positioned on a lower side is taken as a case where the relative slope condition of the road surface portion corresponding to the line region is a declivity.

### BRIEF DESCRIPTION OF DRAWINGS

FIG. 1 is a schematic diagram that illustrates a schematic structure of an in-vehicle device control system in the present embodiment.

FIG. 2 is a schematic diagram that illustrates a schematic structure of an imaging unit and an image analysis unit that constitute the in-vehicle device control device.

FIG. 3 is an enlarged schematic diagram of an optical filter and an image sensor in an imaging part of the imaging unit when viewed from a direction perpendicular to a light transmission direction.

FIG. 4 is an explanatory diagram that illustrates a region division pattern of the optical filter.

FIG. 5 is a functional block diagram related to road surface slope identification processing in the present embodiment.

FIG. 6A is an explanatory diagram that illustrates an example of disparity value distribution of a disparity image. FIG. 6B is an explanatory diagram that illustrates a line disparity distribution map (V-disparity map) that illustrates disparity value frequency distribution per line of the disparity image of FIG. 6A.

FIG. 7A is an image example that schematically illustrates an example of an imaged image (brightness image) imaged by the imaging part. FIG. 7B is a graph in which a line disparity distribution map (V-disparity map) calculated by a disparity histogram calculation part is straight-line-approximated.

FIG. 8A is a schematic diagram of the driver's vehicle in a case where a road surface portion on which the driver's vehicle travels is flat, and a road surface in front of the driver's vehicle is also flat when viewed from a direction of a lateral side of the driver's vehicle. FIG. 8B is an image example of a road surface region in an imaged image (brightness image) in the same state as in FIG. 8A, and FIG. 8C is an explanatory diagram that illustrates a line disparity distribution map (V-disparity map) corresponding to FIG. 8B.

FIG. 9A is a schematic diagram of the driver's vehicle in a case where a road surface portion on which the driver's vehicle travels is flat, and a road surface in front of the driver's vehicle is an acclivity when viewed from a direction of a lateral side of the driver's vehicle. FIG. 9B is an image example of a road surface region in an imaged image (brightness image) in the same state as in FIG. 9A, and FIG. 9C is an explanatory diagram that illustrates a line disparity distribution map (V-disparity map) corresponding to FIG. 9B.

FIG. 10A is a schematic diagram of the driver's vehicle in a case where a road surface portion on which the driver's vehicle travels is flat, and a road surface in front of the driver's vehicle is a declivity when viewed from a direction of a lateral side of the driver's vehicle. FIG. 10B is an image example of a road surface region in an imaged image (brightness image) in the same state as in FIG. 10A, and FIG. 10C is an explanatory diagram that illustrates a line disparity distribution map (V-disparity map) corresponding to FIG. 10B.

FIG. 11 is an explanatory diagram that shows two threshold values S1, S2 as slope reference information on a line disparity distribution map (V-disparity map) in which an approximate straight line is drawn.

### DESCRIPTION OF EMBODIMENTS

Hereinafter, a road surface slope-identifying device used in an in-vehicle device control system as a vehicle system according to an embodiment of the present invention will be explained.

Note that the road surface slope-identifying device is employed in not only an in-vehicle device control system but also other systems including an object detection device that detects an object based on an imaged image, for example.

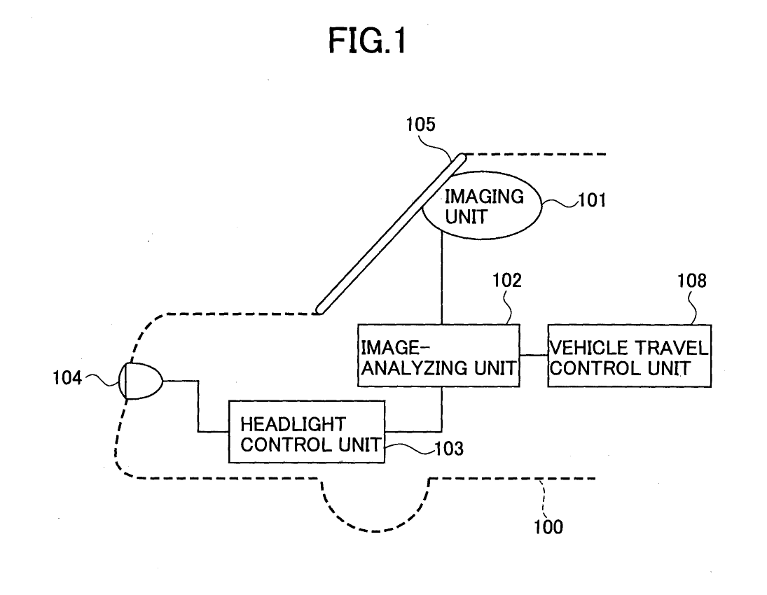

FIG. 1 is a schematic diagram that illustrates a schematic structure of an in-vehicle device control system in the present embodiment. The in-vehicle device control system controls various in-vehicle devices in accordance with a result of identification of an identification target object obtained by using imaged image data of a front region (imaging region) in a travelling direction of a driver's vehicle 100 such as an automobile or the like imaged by an imaging unit included in the driver's vehicle 100.

The in-vehicle device control system includes an imaging unit 101 that images a front region in a travelling direction of the driver's vehicle 100 that travels as an imaging region. The imaging unit 101, for example, is arranged in the vicinity of a room mirror (not-illustrated) of a front window 105 of the driver's vehicle 100. Various data such as imaged image data and the like obtained by imaging of the imaging unit 101 is inputted to an image-analyzing unit 102 as an image processor. The image-analyzing unit 102 analyzes the data transmitted from the imaging unit 101, calculates a location, a direction, a distance of another vehicle in front of the driver's vehicle 100, and detects a slope condition of a road surface in front of the driver's vehicle 100 (hereinafter, referred to as a relative slope condition) with respect to a road surface portion on which the driver's vehicle 100 travels (road surface portion that is located directly beneath the driver's vehicle 100). In detection of another vehicle, by identifying a taillight of the other vehicle, a vehicle in front that travels in the same direction as the driver's vehicle travels is detected, and an oncoming vehicle that travels in the direction opposite to the direction where the driver's vehicle travels is detected by identifying a headlight of the other vehicle.

A result of calculation of the image-analyzing unit 102 is transmitted to a headlight control unit 103.

The headlight control unit 103, for example, from distance data of another vehicle calculated by the image-analyzing unit 102, generates a control signal that controls a headlight 104 as an in-vehicle device of the driver's vehicle 100. In particular, for example, switching control of a high-beam or a low-beam of the headlight 104, and control of a partial block of the headlight 104 are performed such that intense light of the headlight 104 of the driver's vehicle 100 incident to the eyes of a driver of the vehicle in front or the oncoming vehicle is prevented, prevention of dazzling of a driver of the other vehicle is performed, and vision of the driver of the driver's vehicle 100 is ensured.

The calculation result of the image-analyzing unit 102 is also transmitted to a vehicle travel control unit 108. The vehicle travel control unit 108, based on an identification result of a road surface region (travelable region) detected by the image-analyzing unit 102, issues a warning to a driver of the driver's vehicle 100, and performs travel assistance control such as a steering wheel or brake control of the driver's vehicle 100, in a case where the driver's vehicle 100 deviates from the travelable region, or the like. The vehicle travel control unit 108, based on an identification result of a relative slope condition of a road surface detected by the image-analyzing unit 102, issues a warning to a driver of the driver's vehicle 100, and performs travel assistance control such as an accelerator wheel or brake control of the driver's vehicle 100, in a case of slowing down or speeding up of the driver's vehicle 100 due to a slope of the road surface, or the like.

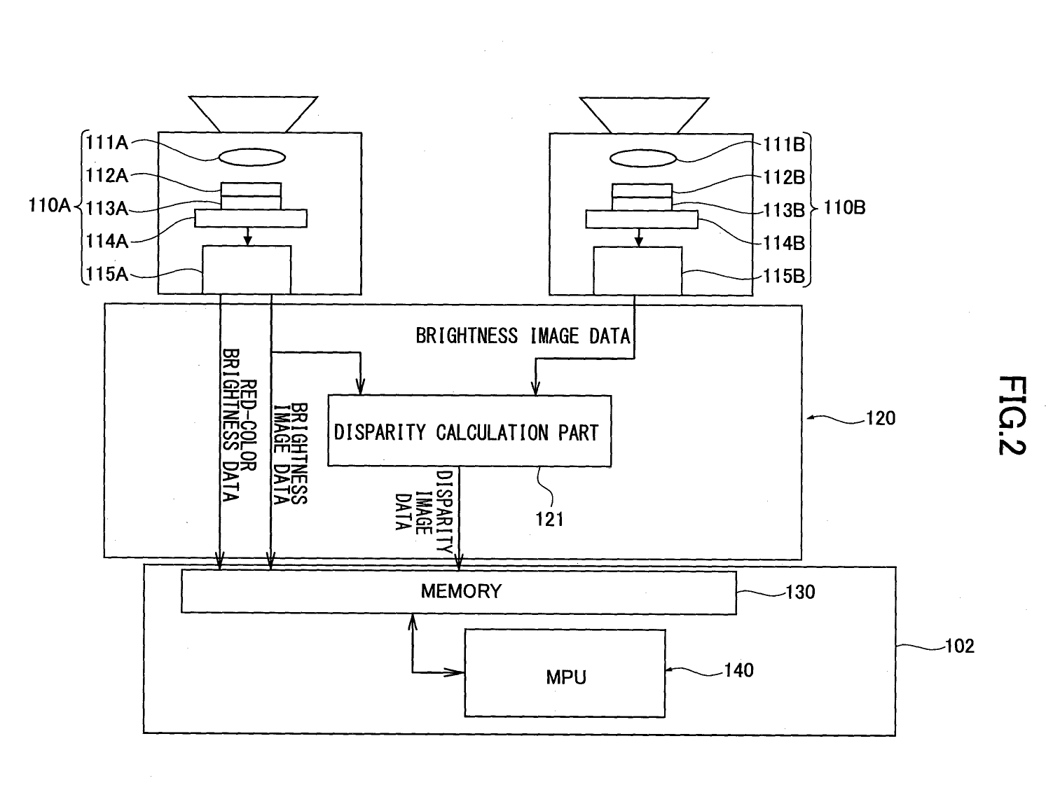

FIG. 2 is a schematic diagram that illustrates a schematic structure of the imaging unit 101 and the image-analyzing unit 102.

The imaging unit 101 is a stereo camera having two imaging parts 110A, 110B as an imager, and the two imaging parts 110A, 110B have the same structures. As illustrated in FIG. 2, the imaging parts 110A, 110B include imaging lenses 111A, 111B, optical filters 112A, 112B, sensor substrates 114A, 114B including image sensors 113A, 113B where imaging elements are arranged two-dimensionally, and signal processors 115A, 115B, respectively. The sensor substrates 114A, 114B output analog electric signals (light-receiving amounts received by each light-receiving element on the image sensors 113A, 113B). The signal processors 115A, 115B generate imaged image data in which the analog electric signals outputted from the sensor substrates 114A, 114B are converted to digital electric signals and outputted. From the imaging unit 101 in the present embodiment red-color image data, brightness image data, and disparity image data are outputted.

The imaging unit 101 includes a processing hardware part 120 having an FPGA (Field-Programmable Gate Array), and the like. The processing hardware part 120 includes a disparity calculation part 121 as a disparity information generator that calculates a disparity value of each corresponding predetermined image portion between imaged images imaged by each of the imaging parts 110A, 110B, in order to obtain a disparity image from brightness image data outputted from each of the imaging parts 110A, 110B. Here, the term “disparity value” is as follows. One of imaged images imaged by either of the imaging parts 110A, 110B is taken as a reference image, and the other of those is taken as a comparison image. A position shift amount between a predetermined image region in the reference image including a certain point in the imaging region and a predetermined image region in the comparison image including the corresponding certain point in the imaging region is calculated as a disparity value of the predetermined image region. By using a principle of triangulation, from the disparity value, a distance to the certain point in the imaging region corresponding to the predetermined image region is calculated.

The image-analyzing unit 102 has a memory 130 and an MPU (Micro Processing Unit) 140. The memory 130 stores red-color image data, brightness image data, and disparity image data that are outputted from the imaging unit 101. The MPU 140 includes software that performs identification processing of an identification target object, disparity calculation control, and the like. The MPU 140 performs various identification processings by using the red-color image data, brightness image data, and disparity image data stored in the memory 130.

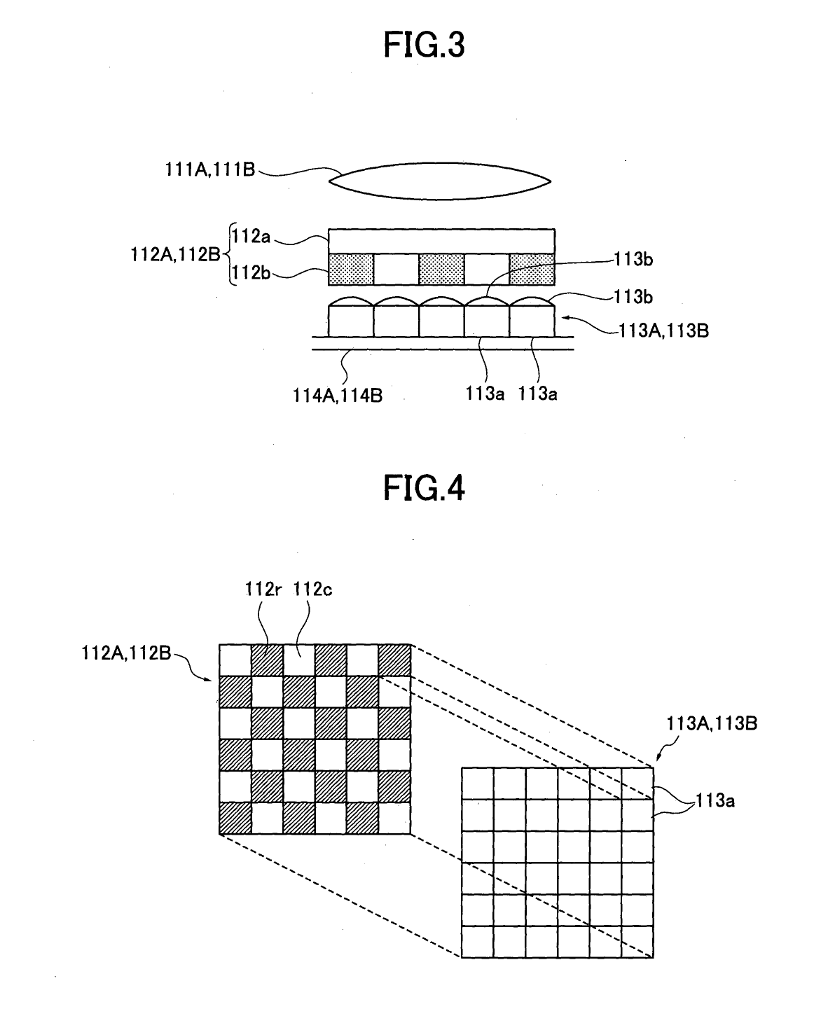

FIG. 3 is an enlarged schematic diagram of the optical filters 112A, 112B and the image sensors 113A, 113B when viewed from a direction perpendicular to a light transmission direction.

Each of the image sensors 113A, 113B is an image sensor using a CCD (Charge-coupled Device), a CMOS (Complementary Metal-Oxide Semiconductor), or the like, and as an imaging element (light-receiving element) of which, a photodiode 113a is used. The photodiode 113a is two-dimensionally arranged in an array manner per imaging pixel: In order to increase light collection efficiency of the photodiode 113a, a microlens 113b is provided on an incident side of each photodiode 113a. Each of the image sensors 113A, 113B is bonded to a PWB (Printed Wiring Board) by a method of wire bonding, or the like, and each of the sensor substrates 114A, 114B is formed.

On a surface on a side of the microlens 113b of each image sensor 113A, 113B, the optical filters 112A, 113B are adjacently arranged, respectively. As illustrated in FIG. 3, each of the optical filters 112A, 112B is formed such that a spectral filter layer 112b is formed on a transparent-filter substrate 112a; however, in place of a spectral filter, or in addition to a spectral filter, another optical filter such as a polarization filter, or the like may be provided. The spectral filter layer 112b is regionally-divided so as to correspond to each photodiode 113a on the image sensors 113A, 113B.

Between the optical filters 112A, 112B and the image sensors 113A, 113B, there may be a gap, respectively; however, if the optical filters 112A, 112B are closely contacted with the image sensors 113A, 113B, it is easy to conform a boundary of each filter region of the optical filters 112A, 112B to a boundary between photodiodes 113a on the image sensors 113A, 113B. The optical filters 112A, 112B and the image sensors 113A, 113B may be bonded by a UV adhesive agent, or in a state of being supported by a spacer outside a range of effective pixels used for imaging, four-side regions outside of the effective pixels may be UV-bonded or thermal-compression-bonded.

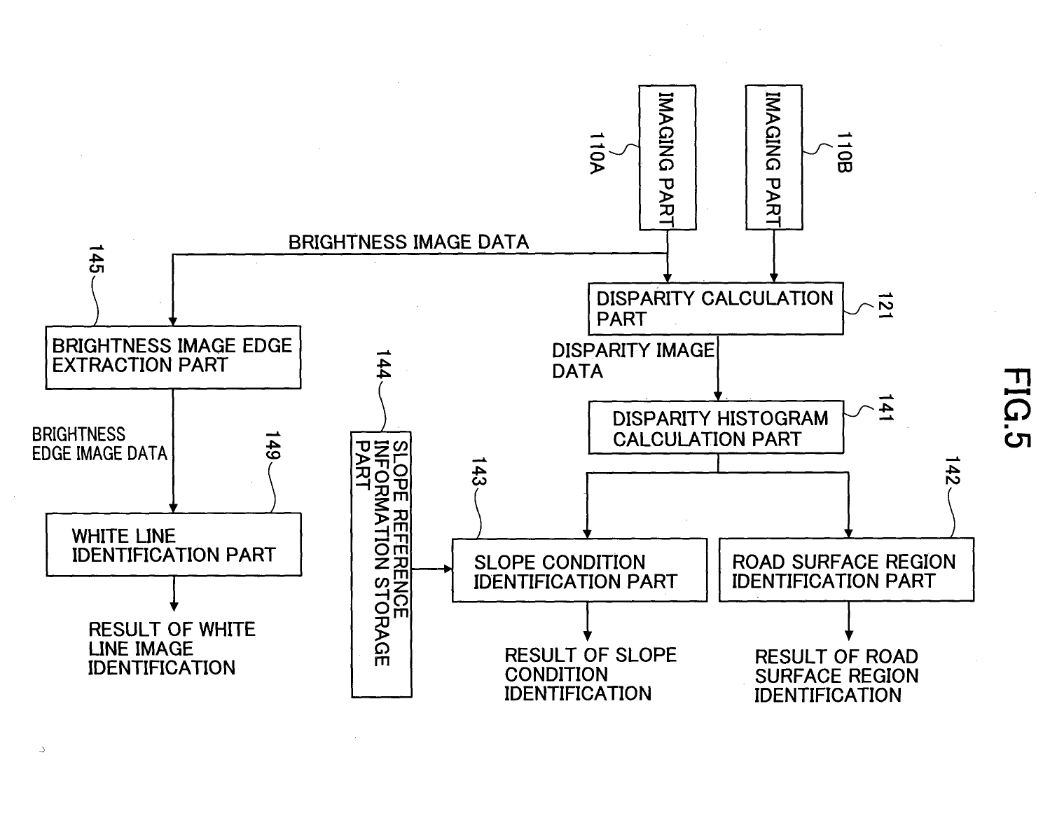

FIG. 4 is an explanatory diagram that illustrates a region division pattern of the optical filters 112A, 112B.

The optical filters 112A, 112B include two types of regions of a first region and a second region, which are arranged for each photodiode 113a on the image sensors 113A, 113B, respectively. Thus, a light-receiving amount of each photodiode 113a on the image sensors 113A, 113B is obtained as spectral information based on types of the regions of the spectral filter layer 112b through which light to be received is transmitted.

In each of the optical filters 112A, 112B, the first region is a red-color spectral region 112r that selects and transmits only light in a red-color wavelength range, and the second region is a non-spectral region 112c that transmits light without performing wavelength selection. In the optical filters 112A, 112B, as illustrated in FIG. 4, the first region 112r and the second region 112c are arranged in a checker manner and used. Therefore, in the present embodiment, a red-color brightness image is obtained from an output signal of an imaging pixel corresponding to the first region 112r, and a non-spectral brightness image is obtained from an output signal of an imaging pixel corresponding to the second region 112c. Thus, according to the present embodiment, it is possible to obtain two types of imaged image data corresponding to the red-color brightness image and the non-spectral brightness image by one imaging processing. In those imaged image data, the number of image pixels is smaller than the number of imaging pixels; however, in order to obtain an image with higher resolution, generally-known image interpolation processing may be used.

The red-color brightness image data thus obtained is used for detection of a taillight that glows red, for example. And the non-spectral brightness image data is used for detection of a white line as a lane line, or a headlight of an oncoming vehicle, for example.

Next, road surface slope identification processing as a feature of the present invention will be explained.

FIG. 5 is a functional block diagram relevant to the road surface slope identification processing according to the present embodiment.

The disparity calculation part 121 uses an imaged image of the imaging part 110A as a reference image, and an imaged image of the imaging part 110B as a comparison image. The disparity calculation part 121 calculates disparity between them, generates a disparity image, and outputs it. And with respect to a plurality of image regions in the reference image, a pixel value is calculated based on the calculated disparity value. An image expressed based on a pixel value of each calculated image region is a disparity image.

In particular, with respect to a certain line of a reference image in which a plurality of lines are divided in a vertical direction, the disparity calculation part 121 defines a block of a plurality of pixels (for example, 16 pixels×1 pixel) centering on a target pixel. In a line of the comparison image corresponding to the certain line of the reference image, a block of the same size as that of the defined reference image is shifted by 1 pixel in a direction of a horizontal line (in an X direction). And a correlation value showing a correlation between an amount of characteristic showing a characteristic of a pixel value in the block defined in the reference image and an amount of characteristic showing a characteristic of a pixel value of each block of the comparison image is calculated. Based on the calculated correlation value, matching processing that chooses a block of the comparison image that is most correlated with a block of the reference image in each block of the comparison image is performed. And then, a position shift amount between the target pixel in the block of the reference image and a pixel corresponding to the target pixel in the block of the comparison image chosen by the matching processing is calculated as a disparity value. By performing such processing to calculate a disparity value on an entire region or a specific region of the reference image, disparity image is obtained. As disparity image data, the disparity image thus obtained is transmitted to a disparity histogram calculation part 141 as a disparity histogram information generator.

As an amount of characteristic of the block used for the matching processing, for example, each pixel value (brightness value) in the block is used. As a correlation value, for example, the sum of an absolute value of the difference between each pixel value (brightness value) in the block of the reference image data and each pixel value (brightness value) in the block of the comparison image corresponding to each pixel in the block of the reference image is used. In this case, it can be said that the block, the sum of which is smallest, is most correlated.

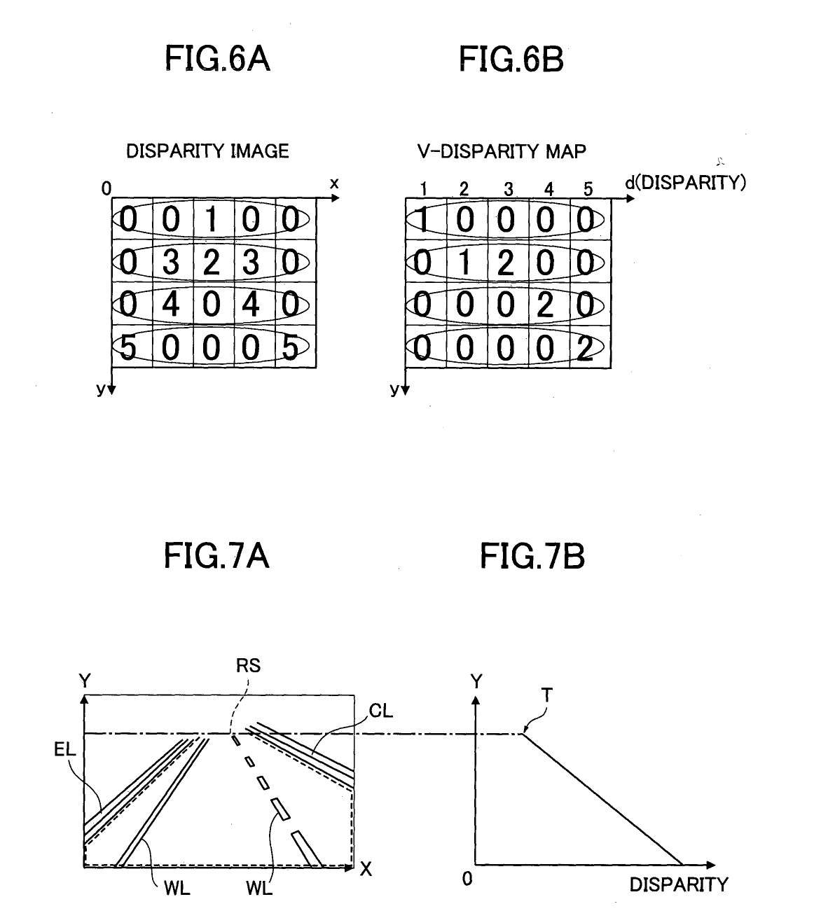

The disparity histogram calculation part 141 obtained disparity image data calculates disparity value frequency distribution with respect to each line of the disparity image data. In particular, when disparity image data having disparity value frequency distribution as illustrated in FIG. 6A is inputted, the disparity histogram calculation part 141 calculates disparity value frequency distribution per line as illustrated in FIG. 6B and outputs it. From information of the disparity value frequency distribution per line thus obtained, for example, on a two-dimensional plane in which a position in the longitudinal direction in a disparity image and a disparity value are set in a longitudinal direction and a lateral direction, respectively, a line disparity distribution map (V-disparity map) in which each pixel on the disparity image is distributed is obtained.

FIG. 7A is an image example that schematically shows an example of an imaged image (brightness image) imaged by the imaging part 110A. FIG. 7B is a graph in which pixel distribution on the line disparity map (V-disparity map) is linearly-approximated from the disparity value frequency distribution per line calculated by the disparity histogram calculation part 141.

In the image example illustrated in FIG. 7A, a state where the driver's vehicle 100 travels on a left lane of a straight road having a median and two lanes each is being imaged. Reference sign CL is a median image portion that shows a median, reference sign WL is a white line image portion (lane boundary image portion) that shows a white line as a lane boundary, and reference sign EL is a difference in level on a roadside image portion that shows a difference in level of a curbstone or the like on the roadside. Hereinafter, the difference in level on the roadside image portion EL and the medial image portion CL are denoted together as a difference in level image portion. Additionally, a region RS surrounded by a broken-line is a road surface region on which a vehicle travels marked by the median and the difference in level on the roadside.

In the present embodiment, in a road surface region identification part 142 as a road surface image region identifier, from disparity value frequency distribution information of each line outputted from the disparity histogram calculation part 141, the road surface region RS is identified. In particular, the road surface region identification part 142 firstly obtains disparity value frequency distribution information of each line from the disparity histogram calculation part 141, and performs processing in which pixel distribution on a line disparity distribution map defined by the information is straight-line approximated by a method of least-squares, the Hough transform, or the like. An approximate straight line illustrated in FIG. 7 thus obtained is a straight line that has a slope in which a disparity value becomes smaller as it approaches an upper portion of an imaged image, in (a downside of) a line disparity distribution map corresponding to (a downside of) a disparity image. That is, the pixels distributed on the approximate straight line or in the vicinity thereof (pixels on the disparity image) exist at an approximately same distance in each line on the disparity image, occupancy of which is highest, and show an object a distance of which becomes continuously farther in the upper portion of the imaged image.

Here, since the imaging part 110A images a front region of the driver's vehicle, as to contents of a disparity image of which, as illustrated in FIG. 7A, occupancy of the road surface region RS is highest in a downside of the imaged image, and a disparity value of the road surface region RS becomes smaller as it approaches the upper portion of the imaged image. Additionally, in the same line (lateral line), pixels constituting the road surface region RS have approximately the same disparity values. Therefore, the pixels defined from the disparity value frequency distribution information of each line outputted from the disparity histogram calculation part 141 and distributed on the approximate straight line on the above-described line disparity distribution map (V-disparity map) or in the vicinity thereof are consistent with a feature of the pixels constituting the road surface region RS. Therefore, the pixels distributed on the approximate straight line illustrated in FIG. 7B or in the vicinity thereof are estimated to be the pixels constituting the road surface region RS with high accuracy.

Thus, the road surface region identification part 142 in the present embodiment performs straight-line approximation on the line disparity distribution map (V-disparity map) calculated based on the disparity value frequency distribution information of each line obtained from the disparity histogram calculation part 141, defines the pixels distributed on the approximate straight line or in the vicinity thereof as the pixels that show the road surface, and identifies an image region occupied with the defined pixels as the road surface region RS. Note that on the road surface, a white line also exists as illustrated in FIG. 7A; however, the road surface region identification part 142 identifies the road surface region RS including the white line image portion WL.

An identification result of the road surface region identification part 142 is transmitted to a subsequent processor, and used for various processings. For example, in a case of displaying an imaged image of a front region of the driver's vehicle imaged by the imaging unit 101 on an image display device in a cabin of the driver's vehicle, based on the identification result of the road surface region identification part 142, display processing is performed such that the road surface region RS is easily visibly recognized such as a corresponding road surface region RS on the displayed image being highlighted, or the like.

The disparity value frequency distribution information of each line outputted from the disparity histogram calculation part 141 is also transmitted to a slope condition identification part 143 as a slope condition identifier. Firstly, the slope condition identification part 143 selects a group of disparity values consistent with the feature of the pixels that show the road surface region RS from the disparity value frequency distribution information of each line outputted from the disparity histogram calculation part 141. In particular, based on the disparity value frequency distribution information, from a disparity value or a disparity value range having frequency that exceeds a predetermined specified value, a group of disparity value or a disparity value range consistent with a feature in which a disparity value becomes smaller as it approaches an upper portion of an imaged image is selected. The disparity value having such a feature is a disparity value corresponding to an approximate straight line illustrated in FIG. 7B. Therefore, the slope condition identification part 143 performs straight-line approximation on pixel distribution on a line disparity distribution map (V-disparity map) by a method of least-squares, Hough transform, and the like, and selects a disparity value or a disparity value range of pixels on the approximate straight line or in the vicinity thereof.

Then, the slope condition identification part 143 extracts a specific disparity value or disparity value range that is positioned in an uppermost portion of the imaged image from the selected disparity value or disparity value range, and specifies a line to which the extracted specific disparity value or disparity value range belongs. The line thus specified is a line in which an upper end portion T of the approximate straight line illustrated in FIG. 7B exists. The line, as illustrated in FIG. 7A, shows a position in the vertical direction (height in an imaged image) in the imaged image of a top portion of the road surface region RS in the imaged image.

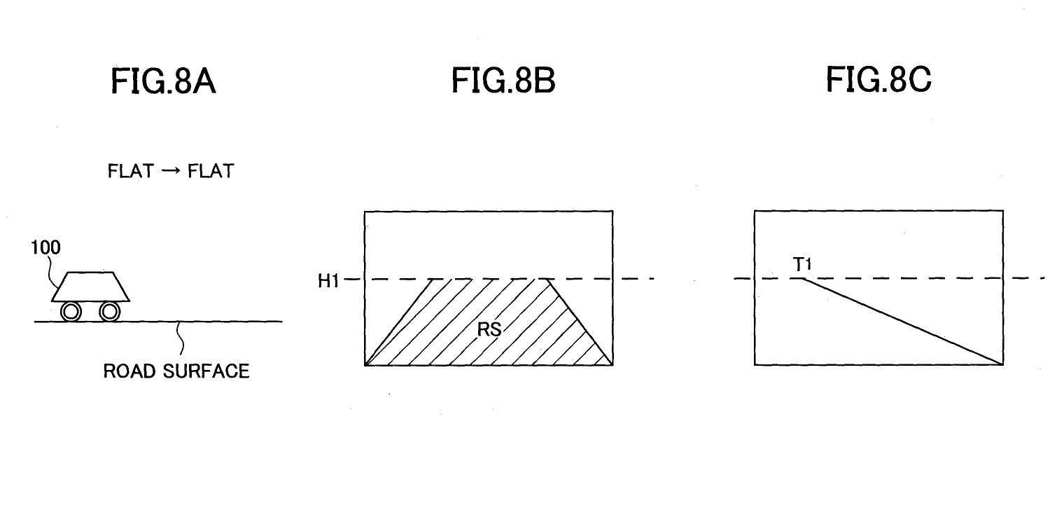

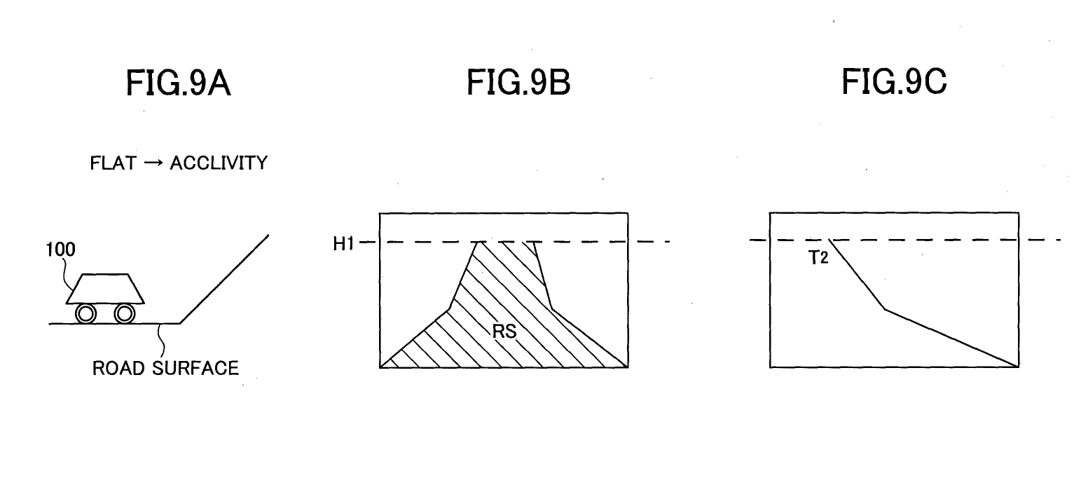

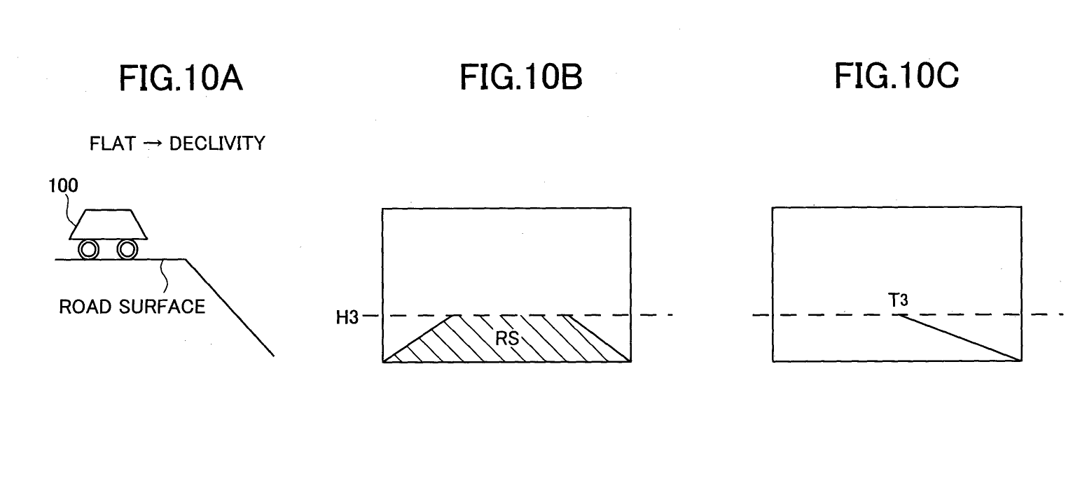

Here, as illustrated in FIG. 8A, in a case where a slope condition (relative slope condition) of a road surface in front of the driver's vehicle 100 with respect to a road surface portion on which the driver's vehicle 100 travels (road surface portion positioned directly beneath the driver's vehicle 100) is flat, height in an imaged image of a top portion of a road surface region RS in the imaged image (road surface portion corresponding to a farthest position of a road surface shown in the imaged image) is taken as H1, as illustrated in FIG. 8B. In a case where as illustrated in FIG. 9A the relative slope condition is an acclivity, height H2 in an imaged image of a top portion of a road surface region RS in the imaged image is positioned on an upper side in the imaged image compared to the height H1 in the case where the relative slope condition is flat, as illustrated in FIG. 9B. In a case where the relative slope condition is a declivity as illustrated in FIG. 10A, height H3 in an imaged image of a top portion of a road surface region RS in the imaged image is positioned on a lower side compared to the height H1 in the case where the relative slope condition is flat, as illustrated in FIG. 10B. Therefore, it is possible to obtain a relative slope condition of a road surface in front of the driver's vehicle in accordance with the height in the imaged image of the top portion of the road surface region RS in the imaged image.

As described above, the line to which the extracted specific disparity value or disparity value range, that is, each height of upper end portions T1, T2, T3 of the approximate straight lines in the line disparity distribution maps (V-disparity map) illustrated in FIGS. 8C, 9C, 10C corresponds to each height H1, H2, H3 in the imaged image of the top portions of the road surface regions RS in the imaged images. Therefore, the slope condition identification part 143 defines each height (line) of the upper end portions T1, T2, T3 of the obtained approximate straight lines, and performs processing that identifies the relative slope condition from each height (line) of the upper end portions T1, T2, T3 of the approximate straight lines.

In the present embodiment, by comparing each height of the upper end portions T1, T2, T3 of the approximate straight lines with two threshold values indicated by slope reference information previously stored in a slope reference information storage part 144 as a slope reference information storage device, respectively, regarding the relative slope condition, three types of identification of flat, an acclivity, and a declivity are performed, and in accordance with the identification result, the relative slope condition is identified.

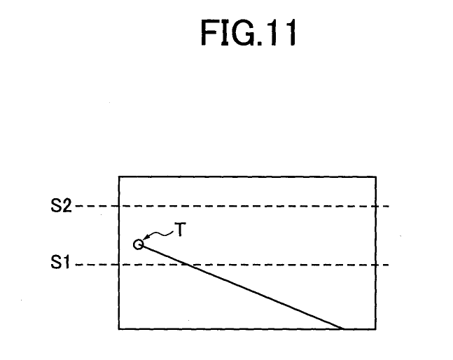

FIG. 11 is an explanatory diagram illustrating two threshold values S1, S2 in a line disparity distribution map (V-disparity map) that illustrates the approximate straight line.

In a case where height of an upper end portion T of the approximate straight line satisfies a condition: S1≦T<S2, it is identified that the relative slope condition is flat. In a case where the height of the upper end portion T of the approximate straight line satisfies a condition: S2≦T, it is identified that the relative slope condition is an acclivity. In a case where the height of the upper end portion T of the approximate straight line satisfies a condition: S1>T, it is identified that the relative slope condition is a declivity.

An identification result of the slope condition identification part 143 that thus identifies a relative slope condition is transmitted to a subsequent processor, and used for various processings. For example, the identification result of the slope condition identification part 143 is transmitted to the vehicle travel control unit 108, and in accordance with the relative slope condition, travel assistance control is performed such as performing speed-up or slow-down of the driver's vehicle 100, issuing a warning to a driver of the driver's vehicle 100, or the like.

In the present embodiment, information that is necessary to identify a relative slope condition is information regarding the height of the upper end portion T of the approximate straight line. Therefore, it is not necessary to obtain an approximate straight line with respect to an entire image, and with respect to a limited range in which the upper end portion T of the approximate straight line can exist (range of an imaged image in the vertical direction), it is only necessary to obtain the height of the upper end portion T of the approximate straight line. For example, when the relative slope condition is flat, an appropriate straight line is obtained only with respect to a range of predetermined height including a top portion of a road surface region RS that shows a road surface on which the driver's vehicle travels, and then the upper end portion T is defined. In particular, an appropriate straight line with respect to a range between the above-described threshold values S1 and S2 is obtained. And, in a case where the upper end portion T of the obtained approximate straight line satisfies the condition: S1≦T<S2, it is identified that the relative slope condition is flat. In a case where the upper end portion T of the obtained approximate straight line is consistent with the threshold value S2, it is identified that the relative slope condition is an acclivity. In a case where the approximate straight line is not obtained, it is identified that the relative slope condition is a declivity.

The brightness image data imaged by the imaging part 110A is transmitted to a brightness image edge extraction part 145. The brightness image edge extraction part 145 extracts a portion in which a pixel value (brightness) of the brightness image changes to equal to or more than a specified value as an edge portion, and from the result of the extraction, brightness edge image data is generated. The brightness edge image data is image data in which an edge portion and a non-edge portion are expressed by binary. As edge extraction methods, any known methods of edge extraction are used. The brightness edge data generated by the brightness image edge extraction part 145 is transmitted to a white line identification processing part 149.

The white line identification processing part 149 performs processing that identifies the white line image portion WL that shows the white line on the road surface based on the brightness edge image data. On many roads, a white line is formed on a blackish road surface, and in the brightness image, brightness of the white line image portion WL is sufficiently larger than that of other portions on the road surface. Therefore, the edge portion having a brightness difference that is equal to or more than a predetermined value in the brightness image is more likely to be an edge portion of the white line. Additionally, since the white line image portion WL that shows the white line on the road surface is shown in a line manner in the imaged image, by defining the edge portion that is arranged in the line manner, it is possible to identify the edge portion of the white line with high accuracy. Therefore, the white line identification processing part 149 performs a straight line approximation such as a method of least-squares, Hough transform operation, or the like on the brightness edge image data obtained from the brightness image edge extraction part 145, and identifies the obtained approximate straight line as the edge portion of the white line (white line image portion WL that shows the white line on the road surface).

The white line identification result thus identified is transmitted to a subsequent processor, and used for various processings. For example, in a case where the driver's vehicle 100 deviates from the lane on which the driver's vehicle 100 travels, or the like, it is possible to perform travel assistance control such as issuing a warning to a driver of the driver's vehicle 100, controlling a steering wheel or a brake of the driver's vehicle 100, and the like.

Note that in the white line identification processing, by using the identification result of the road surface region RS identified by the above road surface region identification part 142, and performing the identification processing of the white line image portion WL on a brightness edge portion of the road surface region RS, it is possible to reduce load of the identification processing, and improve identification accuracy.

In an automatic brake function, a driver's vehicle speed adjustment function, or the like for which road surface slope information is suitably used, in many cases, there is no need for detailed slope information as road surface irregularity information identified by the road surface-identifying device disclosed in Japanese Patent Application Publication number 2002-150302, and information that indicates a simple slope condition as to whether the road surface in the direction of the driver's vehicle that travels is flat, an acclivity, or a declivity is sufficient enough. Therefore, in the present embodiment, processing that identifies such a simple slope condition is performed; however, it is possible to identify more detailed slope information.

For example, as slope reference information, if equal to or more than three threshold values, for example, four threshold values are set, it is possible to identify five slope conditions such as flat, a moderate acclivity, a precipitous acclivity, a moderate declivity, and a precipitous declivity.

Additionally, for example, if not only height (line) of an upper end portion T of an approximate straight line on a line disparity distribution map (V-disparity map) but also height (line) of a plurality of portions (a plurality of disparity values) on an approximate straight line on a line disparity distribution map (V-disparity map) are defined, it is possible to identify relative slope conditions of the plurality of portions. In other words, if a slope of an approximate straight line connecting to two portions on a line disparity distribution map (V-disparity map) is larger, or smaller than a slope in a case where a relative slope condition is flat, it is possible to identify that a relative slope condition of a road surface portion corresponding to a portion between the two portions is an acclivity, or a declivity, respectively. Note that in this case, when performing the straight-line approximation processing of the line disparity distribution map (V-disparity map), the line disparity distribution map (V-disparity map) is divided, for example, per actual distance of 10 m, and with respect to each division, the straight-line approximation processing is performed individually.

Additionally, the present embodiment is an example that identifies a slope condition of a road surface in front of the driver's vehicle 100 with respect to a road surface portion on which the driver's vehicle travels (road surface portion positioned under the driver's vehicle), that is, an example that identifies a relative slope condition; however, it is possible to obtain an absolute slope condition of the road surface in front of the driver's vehicle when a device that obtains an inclined state of a driver's vehicle with respect to a traveling direction (whether the inclined state of the driver's vehicle is in a flat state, an inclined-forward state, an inclined-backward state, or the like) is provided.

The above-described is an example, and the present invention has specific effects for the following aspects.

### (Aspect A)

A road surface slope-identifying device having a disparity information generator that generates disparity information based on a plurality of imaged images obtained by imaging a front region of a driver's vehicle by a plurality of imagers such as the two imaging parts 110A, 110B, which identifies a slope condition of a road surface in front of the driver's vehicle with respect to a road surface portion on which the driver's vehicle travels (relative slope condition) based on the disparity information generated by the disparity information generator such as a disparity calculation part 121, includes a disparity histogram information generator such as a disparity histogram calculation part 141 that generates disparity histogram information that shows disparity value frequency distribution in each of line regions obtained by plurally-dividing the imaged image in a vertical direction based on the disparity information generated by the disparity information generator; and a slope condition identifier such as a slope condition identification part 143 that performs slope condition identification processing in which a group of disparity values or a disparity value range that is consistent with a feature in which a disparity value becomes smaller as it approaches an upper portion of the imaged image from a disparity value or a disparity value range having frequency that exceeds a predetermined specified value is selected based on the disparity histogram information, and in accordance with the selected group of disparity values or disparity value range, the slope condition of the road surface in front of the driver's vehicle with respect to the road surface portion on which the driver's vehicle travels is identified.

According to the above, it is possible to indentify a relative slope condition by low-load processing, and therefore, it is possible to perform identification processing of the relative slope condition in a short time, and also deal with real-time processing with respect to, for example, a motion image of 30 FPS (frames per second).

### (Aspect B)

The road surface slope-identifying device according to Aspect A, in which the slope condition identifier extracts a specific disparity value or disparity value range that is positioned in an uppermost portion of the imaged image from the selected group of disparity values or disparity value range, and performs the slope condition identification processing that identifies the slope condition in accordance with a line region to which the extracted specific disparity value or disparity value range belongs.

According to the above, it is possible to identify a simple relative slope condition as to whether it is flat, an acclivity, a declivity with a lower processing load.

### (Aspect C)

The road surface slope-identifying device according to Aspect A or Aspect B, further including: a slope reference information storage device that stores a plurality of slope reference information corresponding to at least two slope conditions that express a position in the vertical direction in the imaged image in which a top portion of a road surface image that shows a road surface in front of the driver's vehicle in the imaged image is positioned, in which the slope condition identifier compares a position in the vertical direction in the imaged image of the line region to which the specific disparity value or disparity value range belongs with a position in the vertical direction in the imaged image expressed by the slope reference information stored in the slope reference storage device, and performs slope condition identification processing that identifies the slope condition by use of a result of the comparison. According to the above, it is possible to identify a relative slope condition by lower load processing.

### (Aspect D)

The road surface slope-identifying device according to Aspect B or Aspect C, in which the slope condition identifier performs the slope condition identification processing on only a disparity value or a disparity value range with respect to a line region in a limited range including a line region corresponding to a position in the vertical direction of the imaged image in which a top portion of a road surface image that shows the road surface in front of the driver's vehicle when the slope condition of the road surface in front of the driver's vehicle with respect to the road surface portion on which the driver's vehicle travels is flat.

According to the above, it is possible to reduce a processing load compared with a case where a slope condition identifying processing is performed on disparity values or a disparity value range in an entire image as a target, and additionally reduce a memory region being used, and therefore, it is possible to achieve memory reduction.

### (Aspect E)

The road surface slope-identifying device according to any one of Aspects A to D, further including: a road surface image region identifier that selects a group of disparity values or a disparity value range that is consistent with a feature in which a disparity value becomes smaller as it approaches an upper portion of the imaged image from a disparity value or a disparity value range having frequency that exceeds a predetermined specified value based on the disparity histogram information, and identifies an image region to which a pixel in the imaged image corresponding to the selected group of disparity value and disparity value range as a road surface image region that shows a road surface.

According to the above, it is possible to identify not only a relative slope condition of a road surface on which the driver's vehicle travels but also identify a travelable range on which the driver's vehicle travels, and therefore, based on the relative slope condition and information on the travelable range, it is possible to perform higher in-vehicle device control.

### (Aspect F)

The road surface slope-identifying device according to any one of Aspects A to E, in which the disparity information generator detects image portions corresponding to each other between the plurality of imaged images obtained by imaging the front region of the driver's vehicle by the plurality of imagers, and generates disparity information in which a position shift amount between the detected image portions is taken as a disparity value.

According to the above, it is possible to obtain highly-accurate disparity information.

### (Aspect G)

The road surface slope-identifying device according to any one of Aspects A to F, further including: the plurality of imagers.

According to the above, it is possible to place the road surface slope-identifying device in a vehicle and use it as an application for the vehicle.

### (Aspect H)

The road surface slope-identifying device according to Aspect G, in which the plurality of imagers are motion image imagers that continuously image the front region of the driver's vehicle.

According to the above, it is possible to identify a relative slope condition by real-time processing with respect to a motion image.

### (Aspect I)

A method of identifying a road surface slope having a step of generating disparity information based on a plurality of imaged images obtained by imaging a front region of a driver's vehicle by a plurality of imagers, which identifies a slope condition of a road surface in front of the driver's vehicle with respect to a road surface portion on which the driver's vehicle travels based on the disparity information generated in the step of generating the disparity information, the method includes the steps of: generating disparity histogram information that shows disparity value frequency distribution in each of line regions by plurally-dividing the imaged image in a vertical direction based on the disparity information generated in the step of generating the disparity information; and identifying a slope condition that performs slope condition identification processing in which a group of disparity values or a disparity value range that is consistent with a feature in which a disparity value becomes smaller as it approaches an upper portion of the imaged image from a disparity value or a disparity value range having frequency that exceeds a predetermined specified value is selected based on the disparity histogram information, and in accordance with the selected group of disparity values or disparity value range, the slope condition of the road surface in front of the driver's vehicle with respect to the road surface portion on which the driver's vehicle travels is identified.

According to the above, it is possible to identify a relative slope condition by low-load processing, and therefore, it is possible to perform identification processing of the relative slope condition in a shorter time, and also deal with real-time processing with respect to a 30 FPS motion image, for example.

### (Aspect J)

A computer program for causing a computer to execute road surface slope identification having a step of generating disparity information based on a plurality of imaged images obtained by imaging a front region of a driver's vehicle by a plurality of imagers, which identifies a slope condition of a road surface in front of the driver's vehicle with respect to a road surface portion on which the driver's vehicle travels based on the disparity information generated in the step of generating the disparity information, the computer program causing the computer to execute the road surface slope identification, includes the steps of: generating disparity histogram information that shows disparity value frequency distribution in each of line regions obtained by plurally-dividing the imaged image in a vertical direction based on the disparity information generated in the step of generating the disparity information; and identifying a slope condition that performs slope condition identification processing in which a group of disparity values or a disparity value range that is consistent with a feature in which a disparity value becomes smaller as it approaches an upper portion of the imaged image from a disparity value or a disparity value range having frequency that exceeds a predetermined specified value, based on the disparity histogram information is selected, and in accordance with the selected group of disparity values or disparity value range, the slope condition of the road surface in front of the driver's vehicle with respect to the road surface portion on which the driver's vehicle travels is identified.

According to the above, it is possible to identify a relative slope condition by low-load processing, and therefore, it is possible to perform identification processing of the relative slope condition in a shorter time, and also deal with real-time processing with respect to a 30 FPS motion image, for example. Note that it is possible for the computer program to be distributed, or acquired in a state of being stored in the storage medium such as the CD-ROM, or the like. By distributing or receiving a signal carrying the computer program and transmitted by a predetermined transmission device via a transmission medium such as a public telephone line, an exclusive line, other communication network, or the like, distribution or acquisition is available. In a case of the distribution, in a transmission medium, at least a part of the program may be transmitted. That is, all the data constituting the computer program is not needed to exist in the transmission medium at one time. The signal carrying the computer program is a computer data signal embodied in a predetermined carrier wave including the computer program. Additionally, a method of transmitting a computer program from a predetermined transmission device includes cases of continuously transmitting, and intermittently transmitting the data constituting the computer program.

According to an embodiment of the present invention, it is possible to identify a slope condition of a road surface in a travelling direction of a driver's vehicle by new identification processing without using the processing used by the road surface-identifying device disclosed in Japanese Patent Application Publication number 2002-150302.

Although the present invention has been described in terms of exemplary embodiments, it is not limited thereto. It should be appreciated that variations may be made in the embodiments described by persons skilled in the art without departing from the scope of the present invention defined by the following claims.

### CROSS-REFERENCE TO RELATED APPLICATIONS

The present application is based on and claims priority from Japanese Patent Application Numbers 2012-123999, filed May 31, 2012 and 2013-55905, filed Mar. 19, 2013, the disclosures of which are hereby incorporated reference herein in their entireties.

1. A road surface slope-identifying device having a disparity information generator that generates disparity information based on a plurality of imaged images obtained by imaging a front region of a driver's vehicle by a plurality of imagers, which identifies a slope condition of a road surface in front of the driver's vehicle with respect to a road surface portion on which the driver's vehicle travels based on the disparity information generated by the disparity information generator, comprising:
a disparity histogram information generator that generates disparity histogram information that shows disparity value frequency distribution in each of line regions obtained by plurally-dividing the imaged image in a vertical direction based on the disparity information generated by the disparity information generator; and
a slope condition identifier that performs slope condition identification processing in which a group of disparity values or a disparity value range that is consistent with a feature in which a disparity value becomes smaller as it approaches an upper portion of the imaged image from a disparity value or a disparity value range having frequency that exceeds a predetermined specified value is selected based on the disparity histogram information, and in accordance with the selected group of disparity values or disparity value range, the slope condition of the road surface in front of the driver's vehicle with respect to the road surface portion on which the driver's vehicle travels is identified.

2. The road surface slope-identifying device according to claim 1, wherein the slope condition identifier extracts a specific disparity value or disparity value range that is positioned in an uppermost portion of the imaged image from the selected group of disparity values or disparity value range, and performs the slope condition identification processing that identifies the slope condition in accordance with a line region to which the extracted specific disparity value or disparity value range belongs.

3. The road surface slope-identifying device according to claim 2, further comprising:
a slope reference information storage device that stores a plurality of slope reference information corresponding to at least two slope conditions that express a position in the vertical direction in the imaged image in which a top portion of a road surface image that shows a road surface in front of the driver's vehicle in the imaged image is positioned,
wherein the slope condition identifier compares a position in the vertical direction in the imaged image of the line region to which the specific disparity value or disparity value range belongs with a position in the vertical direction in the imaged image expressed by the slope reference information stored in the slope reference storage device, and performs slope condition identification processing that identifies the slope condition by use of a result of the comparison.

4. The road surface slope-identifying device according to claim 2, wherein the slope condition identifier performs the slope condition identification processing on only a disparity value or a disparity value range with respect to a line region in a limited range including a line region corresponding to a position in the vertical direction of the imaged image in which a top portion of a road surface image that shows the road surface in front of the driver's vehicle when the slope condition of the road surface in front of the driver's vehicle with respect to the road surface portion on which the driver's vehicle travels is flat.

5. The road surface slope-identifying device according to claim 1, further comprising:
a road surface image region identifier that selects a group of disparity values or a disparity value range that is consistent with a feature in which a disparity value becomes smaller as it approaches an upper portion of the imaged image from a disparity value or a disparity value range having frequency that exceeds a predetermined specified value based on the disparity histogram information, and identifies an image region to which a pixel in the imaged image corresponding to the selected group of disparity value and disparity value range as a road surface image region that shows a road surface.

6. The road surface slope-identifying device according to claim 1, wherein the disparity information generator detects image portions corresponding to each other between the plurality of imaged images obtained by imaging the front region of the driver's vehicle by the plurality of imagers, and generates disparity information in which a position shift amount between the detected image portions is taken as a disparity value.

7. The road surface slope-identifying device according to claim 1, further comprising:
the plurality of imagers.

8. The road surface slope-identifying device according to claim 7, wherein the plurality of imagers are motion image imagers that continuously image the front region of the driver's vehicle.

9. A method of identifying a road surface slope having a step of generating disparity information based on a plurality of imaged images obtained by imaging a front region of a driver's vehicle by a plurality of imagers, which identifies a slope condition of a road surface in front of the driver's vehicle with respect to a road surface portion on which the driver's vehicle travels based on the disparity information generated in the step of generating the disparity information,
the method comprising the steps of:
generating disparity histogram information that shows disparity value frequency distribution in each of line regions by plurally-dividing the imaged image in a vertical direction based on the disparity information generated in the step of generating the disparity information; and
identifying a slope condition that performs slope condition identification processing in which a group of disparity values or a disparity value range that is consistent with a feature in which a disparity value becomes smaller as it approaches an upper portion of the imaged image from a disparity value or a disparity value range having frequency that exceeds a predetermined specified value is selected based on the disparity histogram information, and in accordance with the selected group of disparity values or disparity value range, the slope condition of the road surface in front of the driver's vehicle with respect to the road surface portion on which the driver's vehicle travels is identified.

10. (canceled)

11. The road surface slope-identifying device according to claim 3, wherein the slope condition identifier performs the slope condition identification processing on only a disparity value or a disparity value range with respect to a line region in a limited range including a line region corresponding to a position in the vertical direction of the imaged image in which a top portion of a road surface image that shows the road surface in front of the driver's vehicle when the slope condition of the road surface in front of the driver's vehicle with respect to the road surface portion on which the driver's vehicle travels is flat.

12. A non-transitory computer-readable storage medium storing a computer program for causing a computer to execute road surface slope identification having a step of generating disparity information based on a plurality of imaged images obtained by imaging a front region of a driver's vehicle by a plurality of imagers, which identifies a slope condition of a road surface in front of the driver's vehicle with respect to a road surface portion on which the driver's vehicle travels based on the disparity information generated in the step of generating the disparity information,
the road surface slope identification comprising the steps of:
generating disparity histogram information that shows disparity value frequency distribution in each of line regions by plurally-dividing the imaged image in a vertical direction based on the disparity information generated in the step of generating the disparity information; and
identifying a slope condition that performs slope condition identification processing in which a group of disparity values or a disparity value range that is consistent with a feature in which a disparity value becomes smaller as it approaches an upper portion of the imaged image from a disparity value or a disparity value range having frequency that exceeds a predetermined specified value is selected based on the disparity histogram information, and in accordance with the selected group of disparity values or disparity value range, the slope condition of the road surface in front of the driver's vehicle with respect to the road surface portion on which the driver's vehicle travels is identified.
